(19) United States
(12) Patent Application Publication
(10) Pub. No.: US 2025/0274223 A1
(43) Pub. Date: Aug. 28, 2025

(54) METHODS AND APPARATUSES FOR RESOURCE SELECTION FOR SIDELINK TRANSMISSION

(71) Applicant: LENOVO (BEIJING) LIMITED, Beijing (CN)

(72) Inventors: Jing HAN, Beijing (CN); Haipeng LEl, Beijing (CN); Ran YUE, Beijing (CN); Lianhai WU, Beijing (CN); Haiming WANG, Beijing (CN)

(21) Appl. No.: 18/857,568

(22) PCT Filed: Apr. 18, 2022
(86) PCT No.: PCT/CN2022/087370

§ 371 Date: Oct. 17, 2024

(51) Int. Cl. H04L 1/1812; H04W 72/25; H04W 74/0808

(52) U.S. Cl. CPC H04L 1/1812; H04W 72/25; H04W 74/0808

(57) ABSTRACT

The present application relates to methods and apparatuses for resource selection for sidelink (SL) transmission on unlicensed spectrum. One embodiment of the present disclosure provides a UE, which includes: a transceiver; and a processor coupled with the transceiver, and the processor is configured to perform operations comprising: operation A): determine a first number of consecutive resources based on a hybrid automatic repeat request (HARQ) transmission number of a medium access control protocol data unit (MAC PDU) and a total number of available resources in a channel occupancy (CO); operation B): select the first number of consecutive resources from a resource set indicated by a physical layer.

### TECHNICAL FIELD

The present disclosure relates to wireless communication technology, and more particularly, related to methods and apparatuses for resource selection for sidelink (SL) transmission on an unlicensed spectrum.

### BACKGROUND OF THE INVENTION

Base stations (BSs) and user equipment (UE) may operate in both licensed and unlicensed spectrums. In order to achieve fair coexistence with other wireless systems, a channel access procedure, for example, listen before talk (LBT), is required before a transmitter can start the transmission on an unlicensed spectrum. Only when the LBT is successful, can the transmitter start the transmission on the channel and occupy the channel up to a maximum channel occupancy time (MCOT); otherwise, the transmitter cannot start the transmission or continue to perform LBT until the LBT is successful.

Therefore, it is necessary for a UE to perform the resource selection for sidelink transmission on unlicensed spectrums.

### SUMMARY

One embodiment of the present disclosure provides a UE, which includes: a transceiver; and a processor coupled with the transceiver, and the processor is configured to perform operations comprising: operation A): determine a first number of consecutive resources based on a hybrid automatic repeat request (HARQ) transmission number of a medium access control protocol data unit (MAC PDU) and a total number of available resources in a channel occupancy (CO); and operation B): select the first number of consecutive resources from a resource set indicated by a physical layer.

In some embodiments, the first number equals a smaller one of the HARQ transmission number and the total number of available resources of a CO.

In some embodiments, the processor is further configured to: update the first number of consecutive resources by subtracting the first number by one in the case that the operation B) of selecting the first number of consecutive resources failed; and perform the operation B) again after updating the first number of consecutive resources.

In some embodiments, the processor is further configured to: determine a remaining number of HARQ transmissions for the MAC PDU by subtracting the HARQ transmission number by the first number in the case that the first number is less than the HARQ transmission number; and select resources for the remaining number of HARQ transmissions for the MAC PDU from one or more remaining resources in the resource set indicated by the physical layer.

In some embodiments, the processor is further configured to perform: operation C): select a set of periodic consecutive resources, wherein each period includes the first number of consecutive resources.

In some embodiments, the processor is further configured to perform: operation D): update the first number of consecutive resources by subtracting the first number by one in the case that the operation C) of selecting the set of periodic consecutive resources failed; and perform the operation B) again after operation D).

In some embodiments, the periodic consecutive resources are associated with a number of transmission opportunities for multiple MAC PDUs.

In some embodiments, the processor is further configured to: determine a remaining number of HARQ transmissions for the MAC PDU by subtracting the HARQ transmission number by the first number in the case that the first number is less than the HARQ transmission number; and select resources for the remaining number of HARQ transmissions for the MAC PDU from one or more remaining resources in the resource set indicated by the physical layer.

In some embodiments, the processor is further configured to: determine the resource set based on an internal threshold, wherein the internal threshold is associated with an energy detection threshold for an LBT procedure and a ratio of available resources and total resources in the CO.

In some embodiments, there is no minimum time gap between two consecutive resources among the first number of consecutive resources.

Another embodiment of the present disclosure provides a UE, which includes: a transceiver; and a processor coupled with the transceiver, and the processor is configured to: detect a consistent LBT failure for a resource pool; and select a resource from any pool of resources except the resource pool with the consistent LBT failure.

Another embodiment of the present disclosure provides a UE, which includes: a transceiver; and a processor coupled with the transceiver, and the processor is configured to: determine whether a total number of HARQ retransmission of a MAC PDU has been reached; and determine a last transmission of the MAC PDU based on the total number of HARQ retransmissions selected by the MAC entity has been reached and no LBT failure happened during the transmission of the MAC PDU.

Still another embodiment of the present disclosure provides a method performed by a UE, which includes: operation A): determining a first number of consecutive resources based on a HARQ transmission number of a MAC PDU and a total number of available resources in a channel occupancy (CO); and operation B): selecting the first number of consecutive resources from a resource set indicated by a physical layer.

Still another embodiment of the present disclosure provides a method performed by a UE, which includes: detecting a consistent LBT failure for a resource pool; and selecting a resource from any pool of resources except the resource pool with the consistent LBT failure.

Still another embodiment of the present disclosure provides a method performed by a UE, which includes: determining whether a total number of HARQ retransmission of a MAC PDU has been reached; and determining a last transmission of the MAC PDU based on the total number of HARQ retransmissions selected by the MAC entity has been reached and no LBT failure happened during the transmission of the MAC PDU.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present disclosure.

FIG. 2 illustrates an exemplary consecutive resource reservation for one-shot transmission according to some embodiments of the present disclosure.

FIG. 3 illustrates an exemplary consecutive resource reservation for multi-shot transmission according to some embodiments of the present disclosure.

FIG. 4 illustrates a method performed by a UE for wireless communication according to some embodiments of the present disclosure.

FIG. 5 illustrates a method performed by a UE for wireless communication according to some embodiments of the present disclosure.

FIG. 6 illustrates a method performed by a UE for wireless communication according to some embodiments of the present disclosure.

FIG. 7 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

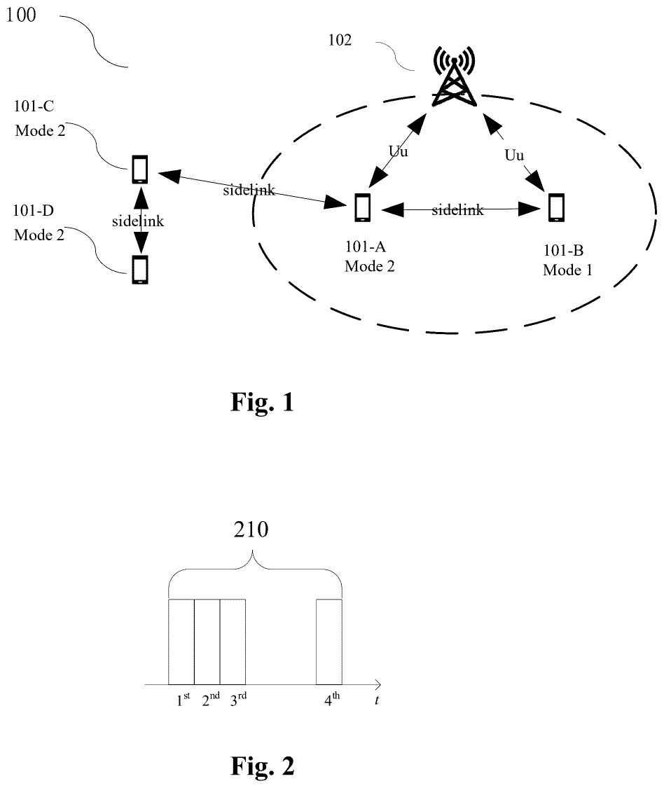

FIG. 1 illustrates an exemplary sidelink communication system in accordance with some embodiments of the present disclosure.

As shown in FIG. 1, the sidelink communication system includes a base station, i.e., BS 102 and some UEs, i.e., UE 101-A, UE 101-B, UE 101-C, and UE 101-D. UE 101-A and UE 101-B are within the coverage of BS 102, and UE 101-C and UE 101-D are not. UE 101-A, UE 101-B, UE 101-C, and UE 101-D may perform sidelink unicast transmission, sidelink groupcast transmission, or sidelink broadcast transmission. It can be contemplated that, in accordance with some other embodiments of the present disclosure, a sidelink communication system may include more or fewer BSs, and more or fewer UEs. Moreover, it can be contemplated that names of UEs (which represent a Tx UE, a Rx UE, etc.) as illustrated and shown in FIG. 1 may be different, e.g., UE 104f, and UE 108g or the like.

In addition, although the UEs as shown in FIG. 1 are illustrated in the shape of a phone, it can be contemplated that a sidelink communication system may include any type of UE. For example, the UE may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE includes wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art. The UE may communicate with the BS 102 via uplink (UL) communication signals.

UE 101-A and UE 101-C may function as transmitting (Tx) UEs, and UE 101-B and UE 101-D function as receiving (Rx) UEs. UE 101-A may exchange messages with UE 101-B, or UE 101-C through a sidelink, for example, PC5 interface as defined in 3GPP documents. UE 101-A may transmit information or data to other UE(s) within the sidelink communication system, through sidelink unicast, sidelink groupcast, or sidelink broadcast. For instance, UE 101-A may transmit data to UE 101-B in a sidelink unicast session. UE 101-A may transmit data to UE 101-B and UE 101-C in a groupcast group by a sidelink groupcast transmission session. Also, UE 101-A may transmit data to UE 101-B and UE 101-C by a sidelink broadcast transmission session.

Both UE 101-A and UE 101-B in the embodiments of FIG. 1 may transmit information to BS 102 and receive control information from BS 102, for example, via NR Uu interface. BS 102 may define one or more cells, and each cell may have a coverage area. As shown in FIG. 1, both UE 101-A and UE 101-B are within the coverage of BS 102, and UE 101-C is outside of the coverage of BS 102.

BS 102 as illustrated and shown in FIG. 1 is not a specific base station, but may be any base station(s) in the sidelink communication system. For example, if the sidelink communication system includes two BSs 102, UE 101-A being within a coverage area of any one the two BSs 102 may be called as a case that UE 101-A is within a coverage of BS 102 in the sidelink communication system; and only UE 101-A being outside of coverage area(s) of both BSs 102 can be called as a case that UE 101-A is outside of the coverage of BS 102 in the sidelink communication system.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BS 102. The BS 102 may communicate with the UE via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with the 5G NR of the 3GPP protocol. For example, BS 102 may transmit data using an OFDM modulation scheme on the DL and the UE may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and the UE may communicate using other communication protocols, such as the IEEE 802.11 family of wireless communication protocols. Further, in some embodiments of the present disclosure, the BS 102 and the UE may communicate over licensed spectrums, whereas in some other embodiments, the BS 102 and the UE may communicate over unlicensed spectrums. The present disclosure is not intended to be limited to the implementation of any particular wireless communication system architecture or protocol.

The UEs may operate in different modes. At least two sidelink resource allocation modes are defined for NR sidelink communication, which are:
1) mode 1: base station schedules sidelink resource(s) to be used by the UE for sidelink transmission(s); and
2) mode 2: the UE determines sidelink transmission resource(s) within sidelink resources configured by the BS or network, or pre-configured sidelink resources; in mode 2, the BS does not schedule the sidelink resources for the UE.

A UE out of the coverage of the network may only function in mode 2, and a UE in the coverage of the network may function in both mode 1 and mode 2, for example, in FIG. 1, UE 101-B is in mode 1, and UE 101-A, UE 101-C, and UE 101-D are in mode 2.

The present disclosure focuses on the sidelink communications among UEs in mode 2, which includes broadcast, groupcast and unicast, and the UEs may perform sidelink transmission on an unlicensed spectrum.

One objective for sidelink transmission on an unlicensed spectrum is to study the unlicensed channel access mechanism impact on sidelink resource reservation schemes. The present disclosure proposes some solutions for resource (re)selection scheme for sidelink transmission on an unlicensed spectrum.

For the unlicensed band, it is found that performing transmission consecutively may avoid channel lost between the transmission intervals. Since the LBT procedure would be performed only once before transmission in the consecutive resources, the performance of UE can be improved. Thus, another objective of the present disclosure is to provide a mechanism for obtaining consecutive resource for initial transmission and retransmissions for the single or multiple MAC PDU.

FIG. 2 illustrates an exemplary consecutive resource reservation for one-shot transmission according to some embodiments of the present disclosure.

A UE in mode 2, for example, UE 101-C as shown in FIG. 1, is configured to perform a sidelink transmission on the unlicensed spectrum, and the UE is required to perform the LBT procedure before each sidelink transmission. If the result of the LBT procedure is not successful, the UE may not perform the sidelink transmission. If the result of the LBT procedure is successful, the UE obtains a CO, for example, a channel occupancy time (COT).

In the case that the UE may perform the one-shot transmission, such as a single MAC PDU transmission (or a MAC CE transmission), and the UE prefers or is configured (or preconfigured) to perform the one-shot transmission in a consecutive manner on the unlicensed spectrum, i.e. the UE may use consecutive transmissions for the MAC PDU transmission (or the MAC CE transmission), the UE may perform the following operations to select consecutive resources for the MAC PDU transmission (or the MAC CE transmission):

Operation 1: the UE may determine the total transmission number of the MAC PDU transmission, which may also be referred to as the HARQ transmission number of the MAC PDU, and hereinafter in the present disclosure the HARQ transmission number of the MAC PDU is represented as: N_HARQnumber.

The HARQ transmission number of the MAC PDU transmission is determined based on the HARQ retransmission number of the MAC PDU transmission, specifically, the HARQ transmission number of the MAC PDU transmission equals to the HARQ retransmission number of the MAC PDU transmission plus one, i.e.: N_HARQnumber+1.

Operation 2 (Optionally): the UE may determine whether the selected resources for the MAC PDU transmission are within an available COT, and if the selected resources are in the available COT, the UE may determine the remaining resources in the available COT which may be used for the MAC PDU transmission. For example, there may be resources for a physical sidelink control channel (PSSCH) transmission, physical sidelink control channel (PSCCH) transmission, and/or physical sidelink feedback channel (PSFCH) transmission within the available COT, and the UE may exclude the resources for the PSFCH transmission, and may perform the MAC PDU transmission with the resources for the PSSCH transmission and the PSCCH transmission. Hereinafter in the present disclosure the remaining resources for the MAC PDU transmission within the COT may be represented as N_COTduration, and may include a number of slots.

Operation 3: the UE may determine the target consecutive resource number, and hereinafter in the present disclosure the target consecutive resource number may be represented as: N_timeresource. The UE may use the target number of consecutive resources for performing the MAC PDU transmission in a consecutive manner. The target consecutive resource number is determined based on the HARQ transmission number of the MAC PDU transmission, i.e. N_HARQnumber, and the remaining resources for the MAC PDU transmission within the available COT, if available COT is considered, i.e. N_COTduration. Specifically, the target consecutive resource number equals the minimum one of the HARQ transmission number of the MAC PDU transmission and the remaining resources for the MAC PDU transmission within the COT. That is, N_timeresource=min {N_HARQnumber, N_COTduration}. In some embodiments, there may not be an available COT, and the target consecutive resource number equals the HARQ transmission number of the MAC PDU transmission, i.e. N_timeresource=N_HARQnumber.

Operation 4: among the available resources indicated by the physical layer, the UE may randomly select time and frequency resources, according to at least one of the following parameters:
1) the target consecutive resource number, N_timeresource;
2) remaining PDB of SL data available in the logical channel(s) allowed on the carrier; or
3) the latency requirement of the triggered MAC CE, which may include: SL CSI reporting, discontinuous reception command (DRX CMD), inter-UE coordination (IUC) request, IUC info etc.

For example, the UE may select the target consecutive resource number of consecutive resources from a resource set indicated by a physical layer.

In some embodiments, the UE may randomly select resources within the available COT. In some other embodiments, the selected resources may not be within the available COT, in which case, the UE may perform the LBT procedure to obtain the COT for the MAC PDU transmission.

Operation 5: the UE may determine whether the resource selection in operation 4 is successful or not. That is, the UE may determine whether N_timeresource consecutive resources have been successfully selected from the available resources indicated by the physical layer.

In the case that the resource selection in operation 4 failed, that is, the UE failed to select N_timeresource consecutive resources from the available resources indicated by the physical layer, the UE may update the N_timeresource by subtracting N_timeresource by 1, i.e. N_timeresource=N_timeresource−1. Thus, the updated N_timeresource equals N_timeresource−1. After updating the value of N_timeresource, the UE may perform operation 4 again with the updated N_timeresource until the UE successfully selects N_timeresource consecutive resources.

In the case that the resource selection in operation 4 is successful, that is, the UE has selected N_timeresource consecutive resources from the available resources indicated by the physical layer, the UE may perform operation 6.

Operation 6: after the UE successfully selects N_timeresource consecutive resources, the UE may determine the left HARQ transmission number for the MAC PDU, which may be represented by: N_leftnumber. The left HARQ transmission number for the MAC PDU equals the HARQ transmission number of the MAC PDU transmission minus the target consecutive resource number, i.e.: N_leftnumber=N_HARQnumber−N_timeresource.

Based on the relation between the number of selected consecutive resources and the HARQ transmission number of the MAC PDU transmission, the following three cases are considered:

Case 1: the HARQ transmission number of the MAC PDU transmission equals the number of selected consecutive resources, i.e. N_HARQnumber=N_timeresource. In this case, the left HARQ transmission number for the MAC PDU is zero, i.e. N_leftnumber=0. The UE does not perform any more operations, and may perform the MAC PDU transmission with the selected consecutive resources, and these transmission opportunities in the selected consecutive resources are considered as selected sidelink grants.

Case 2: the HARQ transmission number of the MAC PDU transmission is larger than the number of selected consecutive resources, and the number of selected consecutive resources is larger than 1. That is: N_HARQnumber>N_timeresource>1.

In this case, the UE may determine the left HARQ transmission number for the MAC PDU is: N_leftnumber=N_HARQnumber−N_timeresource. Since N_HARQnumber>N_timeresource, N_leftnumber is larger than one, and there is one or more MAC PDU (re)transmissions left to be transmitted, and there is still an available resource(s), the UE may randomly select time and frequency resources, for N_leftnumber transmissions, according to at least one of the following parameters:
1) the remaining PDB of SL data available in the logical channel(s) allowed on the carrier, or
2) the latency requirement of the triggered MAC CE, which may include SL CSI reporting, DRX CMD, IUC request, IUC info, etc.

It should be noted that the selected resources for the N_leftnumber transmissions may be consecutive resources or not. Within the selected resources, the first resource in time domain is considered as the initial transmission opportunity for the left MAC PDU transmissions, the other resources are considered as the retransmission opportunity(s) for the left MAC PDU transmissions. These transmission opportunities, including the transmission opportunity(s) for N_timeresource MAC PDU transmissions and the transmission opportunity(s) for N_leftnumber MAC PDU transmissions, are all considered as selected sidelink grants.

Case 3: the HARQ transmission number of the MAC PDU transmission is larger than the number of selected consecutive resources, and the number of selected consecutive resources is equal to 1. That is: N_HARQnumber>N_timeresource=1.

That is, only one resource is selected for the MAC PDU transmission, in other words, no consecutive resources are selected. In this case, the UE may perform the HARQ transmission number of MAC PDU transmissions with no consecutive resources.

For example, as shown in FIG. 2, the HARQ retransmission number for the MAC PDU transmission is 3. In operation 1, the UE determines the HARQ transmission number of the MAC PDU by adding the HARQ retransmission number by 1, and determines the HARQ transmission number for the MAC PDU transmission is 4. In operation 2, the UE may determine the remaining resources for the MAC PDU transmission within the available COT is 5, then in operation 3, the UE may determine the target consecutive resource number, i.e., N_timeresource is 4. In operation 4, the UE may select 4 consecutive resources for the MAC PDU transmission, however, the resource selection of 4 consecutive resources failed. In operation 5, the UE may update the N_timeresource by subtracting the N_timeresource by 1, and the updated N_timeresource is 3, the UE performs operation 4 again, i.e. randomly selects 3 consecutive resources among the available resources indicated by the physical layer, and succeeded. Accordingly, the UE selected 3 consecutive resources. The 3 consecutive resources, which are indicated by the block marked by the reference numerals “1^{st},” “2^{nd},” and “3^{rd},” in FIG. 2. In operation 6, the UE determines that left HARQ transmission number for the MAC PDU is 1, which belongs to the above case 1. The UE then randomly selects time and frequency resources for the last transmission if there is still an available resource(s), and the selected resources are indicated by the block marked by the reference numeral “4^{th}” in FIG. 2. After selecting the four resources, the UE may perform the one-shot transmission with the four resources, and the transmission opportunities on these four resources are all considered as selected sidelink grants.

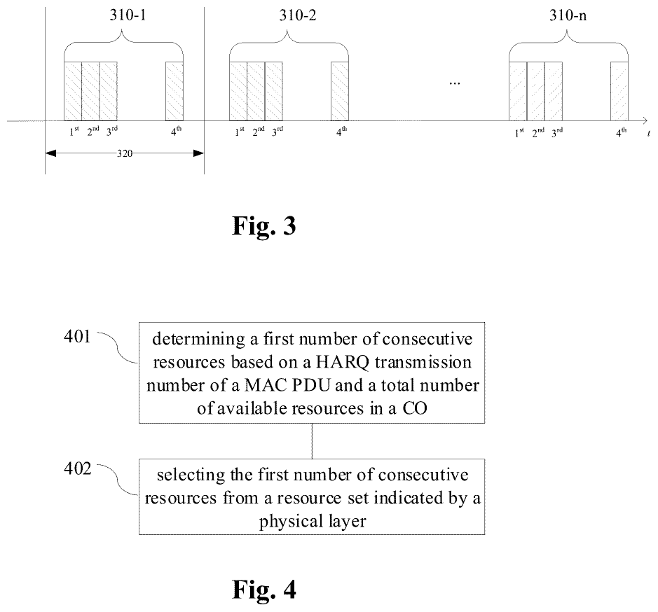

FIG. 3 illustrates an exemplary consecutive resource reservation for multi-shot transmission according to some embodiments of the present disclosure.

Compared with FIG. 2, in FIG. 3, the UE may perform a multi-shot transmission, for example, there are n MAC PDU transmissions 310-1, 310-2, . . . , 310-n shown in FIG. 3, and the UE prefers or is configured (or preconfigured) to perform the multi-shot transmission in a consecutive manner on the unlicensed spectrum, i.e. the UE may use consecutive transmissions for each of the MAC PDU transmission (or the MAC CE transmission), the UE may perform the following operations to select consecutive resources for the MAC PDU transmission (or the MAC CE transmission):

Operation a: the UE may determine the value of N_HARQnumber for each MAC PDU in a similar way as the above operation 1, and the details are omitted here.

Operation b (Optionally): the UE may determine whether the selected resources for the multiple MAC PDU transmission are within an available COT or an expected COT for the multiple MAC PDU transmission. If the selected resources are in the available or the expected COT, the UE may determine the remaining resources in the available or the expected COT which may be used for the MAC PDU transmission.

Operation c: the UE may determine the value of the target consecutive resource number N_timeresource for each MAC PDU in a similar way as the above operation 3, and the details are omitted here.

Operation d: the UE may randomly select time and frequency resources in a similar way as the above operation 4, and the details are omitted here.

Operation e: the UE may determine whether the resource selection in operation d is successful or not in a similar way as the above operation 5.

In the case that the resource selection in operation d failed, that is, the UE failed to select N_timeresource consecutive resources from the available resources indicated by the physical layer, the UE may update the N_timeresource by subtracting N_timeresource by 1, i.e. N_timeresource=N_timeresource−1. Thus, the updated N_timeresource equals N_timeresource−1. After updating the value of N_timeresource, the UE may perform operation d again with the updated N_timeresource until the UE successfully selects N_timeresource consecutive resources.

In the case that the resource selection in operation d is successful, that is, the UE selected N_timeresource consecutive resources from the available resources indicated by the physical layer, the UE may perform operation f.

Operation f: the UE may use the randomly selected resources, i.e. the N_timeresource conservative resources selected in operation d, to select a set of periodic resources spaced by the resource reservation interval for transmissions of PSCCH and PSSCH corresponding to the number of transmission opportunities of MAC PDUs, and each period includes N_timeresource conservative resources. The size of the set is equal to the total number of the MAC PDUs, i.e. n.

Operation g: the UE may determine whether the resource selection of the set of periodic resources in operation f is successful or not. That is, the UE may determine whether the set of periodic resources with each period including N_timeresource consecutive resources has been successfully selected using the randomly selected resources.

In the case that the resource selection of the set of periodic resources in operation g failed, that is, the UE failed to select the set of periodic resources with each period including N_timeresource consecutive resources, the UE may update the N_timeresource by subtracting N_timeresource by 1, i.e. N_timeresource=N_timeresource−1. Thus, the updated N_timeresource equals N_timeresource−1. After updating the value of N_timeresource, the UE may perform operation d again with the updated N_timeresource until the UE successfully selects the set of periodic resources with each period including N_timeresource consecutive resources.

In the case that the resource selection of the set of periodic resources in operation g is successful, that is, the UE has selected the set of periodic resources with each period including N_timeresource consecutive resources, the UE may perform operation h.

Operation h: after the UE successfully selects the set of periodic resources, the UE may determine the left HARQ transmission number for each MAC PDU of the multiple MAC PDUs, the left HARQ transmission number for each MAC PDU is identical, which may be represented by: N_leftnumber. The left HARQ transmission number for each MAC PDU equals the HARQ transmission number of the MAC PDU transmission minus the target consecutive resource number, i.e.: N_leftnumber=N_HARQnumber−N_timeresource.

Based on the relation between the number of selected consecutive resources and the HARQ transmission number of the MAC PDU transmission, the following three cases are considered:

Case A: the HARQ transmission number of the MAC PDU transmission equals the number of selected consecutive resources, i.e. N_HARQnumber=N_timeresource. In this case, the left HARQ transmission number for the MAC PDU is zero, i.e. N_leftnumber=0. The UE does not perform any more operations, and may perform the multi-shot transmission with the set of periodic resources, and these transmission opportunities in the set of periodic resources are considered as selected sidelink grants.

Case B: the HARQ transmission number of the MAC PDU transmission is larger than the number of selected consecutive resources, and the number of selected consecutive resources is larger than 1. That is: N_HARQnumber>N_timeresource>1.

In this case, the UE may determine the left HARQ transmission number for each MAC PDU is: N_leftnumber=N_HARQnumber−N_timeresource. Since N_HARQnumber>N_timeresource, N_leftnumber is larger than one, and there is one or more MAC PDU (re)transmissions left to be transmitted for each MAC PDU, and there is still available resource, the UE may randomly select time and frequency resources, for N_leftnumber transmissions, according to at least one of the following parameters:
1) The remaining PDB of SL data available in the logical channel(s) allowed on the carrier; or
2) the latency requirement of the triggered MAC CE; which may include SL CSI reporting, DRX CMD, IUC request, IUC info, etc.

It should be noted that the selected resources for the N_leftnumber transmissions may be consecutive resources or not. Within the selected resources, the first resource in time domain is considered as the initial transmission opportunity for the left MAC PDU transmissions, the other resources are considered as the retransmission opportunity(s) for the left MAC PDU transmissions. These transmission opportunities, including the transmission opportunity(s) for N_timeresource MAC PDU transmissions and the transmission opportunity(s) for N_leftnumber MAC PDU transmissions, are all considered as selected sidelink grants.

Case C: the HARQ transmission number of the MAC PDU transmission is larger than the number of selected consecutive resources, and the number of selected consecutive resources is equal to 1. That is: N_HARQnumber>N_timeresource=1.

That is, only one resource is selected for the MAC PDU transmission, in other words, no consecutive resources are selected. In this case, the UE may perform the multiple MAC PDU transmissions with no consecutive resources.

For example, in FIG. 3, the UE may perform n MAC PDU transmissions, MAC PDU 310-1, MAC PDU 310-2, . . . , MAC PDU 310-n, and the HARQ retransmission number for each MAC PDU transmission is 3. In operation a, the UE may determine the HARQ transmission number for each MAC PDU is 4. In operation b, the UE may determine the remaining resources for each MAC PDU within the available or expected COT is 5. In operation c, the UE may determine the target consecutive resource number for each MAC PDU, i.e., N_timeresource, is 4, and in operation d, the UE may perform the resource selection of 4 consecutive resources for each MAC PDU transmission. In operation e, the UE determines that the resource selection of 4 consecutive resources failed, and the UE then updates the N_timeresource, and the updated N_timeresource is 3, the UE performs operation d again, i.e. randomly selects 3 consecutive resources, and succeeds. In operation f, the UE uses the randomly selected resources, i.e. the N_timeresource conservative resources selected in operation d, to select a set of periodic resources spaced by the resource reservation interval 320, for transmissions of PSCCH and PSSCH corresponding to the number of transmission opportunities of MAC PDUs, and each period includes N_timeresource conservative resources.

Accordingly, the UE selected a set of periodic resources, each set includes 3consecutive resources for one MAC PDU. The 3 consecutive resources in each set are indicated by the blocks marked by the reference numerals “1^{st},” “2^{nd},” and “3^{rd},” in FIG. 3.

In operation h, the UE determines the left HARQ transmission number for each MAC PDU, which is one, which belongs to the above case A. The UE then randomly selects time and frequency resources for the last transmission if there is still an available resource, and the selected resources are indicated by the blocks marked by the reference numeral “4^{th}” in each set in FIG. 3. After selecting the four resources, the UE may perform the multiple-shot transmission with the set of periodic resources, and the transmission opportunities on these four resources in all the sets are all considered as the selected sidelink grants.

In some embodiments, a UE in mode 2, for example, UE 101-C as shown in FIG. 1, is configured to perform sidelink transmission on the unlicensed spectrum, and the UE is required to perform the LBT procedure before each sidelink transmission, and obtains a COT. If transmission resource (re)selection is triggered, the physical layer would find an available resource set and indicate the available resource set to the MAC layer.

In order to determine an available resource set, the physical layer firstly determines a total resource in a time window, based on the frequency resource number indicated by MAC layer and the remaining PDB of the data. The physical layer may exclude a resource(s) from the total resource set if the measured RSRP of the single slot resource is higher than an internal threshold. The value of the internal threshold is initially set to a threshold, for instance, sl-ThresPSSCH-RSRP-List-r16, which is (pre)configured in the sidelink configuration. That is, only a resource within the time window with the measured RSRP lower than the internal threshold is considered as an available resource, and the resource with the measured RSRP higher than the threshold is considered as an unavailable resource, and is excluded.

After excluding all the unavailable resources, the remaining resources are included in the available resource set, and if the total available resources do not reach 20% of the total resources within the time window, the physical layer will increase internal threshold Th by 3 dB and determine the available resource set again.

In the case that the UE may perform sidelink transmission on an unlicensed spectrum(s), with LBT is enabled, the internal threshold Th cannot exceed the energy detection threshold, which may be determined by the following two thresholds:
1) a threshold of the maximum transmit power and regulatory requirements for performing LBT, which may be represented as: sl-ThresPSSCH-RSRP-List; and
2) a threshold for LBT, which may be represented as: ThresLBT. This threshold is used for detecting whether the channel is occupied, if the detected signal is higher than the threshold for LBT, the UE may consider this channel is occupied and the resources cannot be used.

The initial value of internal threshold Th may be set to the smaller one of the above two thresholds, i.e.: min {sl-ThresPSSCH-RSRP-List, ThresLBT}. The physical layer then determines available resources based on the initial value of the internal threshold Th. If the total available resources do not reach 20% of total resources, and the current internal threshold satisfies both the following two conditions:
1) Th<ThresLBT, and
2) Th+3 dB<ThresLBT.

The current internal threshold Th may be updated by increasing 3 dB, i.e. the updated threshold is Th+3 dB, and the physical layer may determine the available resource again based on the updated internal threshold.

Otherwise, for example, when Th>ThresLBT, the physical layer may stop the procedure of determining an available resource(s) and may indicate the existing available resource set to upper layer.

In some embodiments, a UE in mode 2, for example, UE 101-C as shown in FIG. 1, is configured to perform a sidelink transmission on the unlicensed spectrum, and the UE is required to perform the LBT procedure before each sidelink transmission, and obtains a COT.

If there is data to be transmitted on a specific LCH, or there are triggered MAC CEs for transmission, the UE may select a transmission resource pool before resource (re)selection. If the consistent LBT failure is triggered per resource pool, the UE would avoid selecting the pool which has experienced consistent LBT failure and is under recovery, e.g. a consistent LBT failure has been triggered for the resource pool. That is to say, the UE would select a resource pool which has not been triggered with a consistent LBT failure.

The exemplary amendments to the 3GPP specification may be as follows (the underlined features are newly proposed in the present discourse):

| 2> | if SL data is available in the logical channel: | |
|---|---|---|
| | 3> | if sl-HARQ-FeedbackEnabled is set to enabled for the logical channel: |

| | |
|---|---|
| 4> | select any pool of resources configured with PSFCH resources |
| | among the pools of resources which has not been triggered with |
| | consistent LBT failure; |

| | |
|---|---|
| 3> | else: |

| | |
|---|---|
| 4> | select any pool of resources among the pools of resources which has |
| | not been triggered with consistent LBT failure; |

| 2> | else if a SL-CSI reporting is triggered: | |
|---|---|---|
| | 3> | select any pool of resources among the pools of resources which has |
| | | not been triggered with consistent LBT failure. |

In some embodiments, a UE in mode 2, for example, UE 101-C as shown in FIG. 1, is configured to perform a sidelink transmission on the unlicensed spectrum, and the UE is required to perform the LBT procedure before each sidelink transmission, and obtains a COT.

If there is data to be transmitted on a specific LCH, or there are triggered MAC CEs for transmission, and the UE may perform transmit a (Tx) resource (re)selection check procedure, to check whether there is suitable resource for transmission and whether a new resource needs to be selected. During this procedure, the UE will maintain a counter for resource (re)selection, which may be represented as: SL_RESOURCE_RESELECTION_COUNTER. The initial value of the counter is equal to the number of HARQ retransmissions, which is selected by the MAC entity. The UE may decrease the counter by 1 if this transmission corresponds to the last transmission of the MAC PDU.

In the case that the retransmission number has reached the HARQ retransmission number, and at least one transmission failed due to the LBT failure, the UE does not consider the transmission for the last time as “the last transmission.”

Specifically, in the present disclosure, the last transmission for a MAC PDU is defined as follows: the number of HARQ retransmissions selected by the MAC entity has been reached and no LBT failure happened during the retransmissions, and the retransmission for the last transmission is considered as the last transmission for the MAC PDU. If an LBT failure happened for any transmission, the “last transmission” is determined up to UE implementation.

In some embodiments, a UE in mode 2, for example, UE 101-C as shown in FIG. 1, is configured to perform a sidelink transmission on the unlicensed spectrum, and the UE is required to perform the LBT procedure before each sidelink transmission, and obtains a COT.

If there is data to be transmitted on a specific LCH, or there are triggered MAC CEs for transmission, and the UE prefers to select consecutive resource for the transmission, the UE will not need to guarantee the minimum gap between consecutive resources.

The exemplary amendments to the 3GPP specification may be as follows (the underlined features are newly proposed in the present discourse):

| | |
|---|---|
| 5> | randomly select the time and frequency resources for one or more transmission |

opportunities from the available resources, according to the amount of selected
frequency resources, the selected number of HARQ retransmissions and the
remaining PDB of SL data available in the logical channel(s) allowed on the carrier,
and/or the latency requirement of the triggered SL-CSI by ensuring the minimum
time gap between any two selected resources in case that PSFCH is configured for
this pool of resources, except for consecutive resources, and that a retransmission
resource can be indicated by the time resource assignment of a prior SCI according
to clause 8.3.1.1 of TS 38.212 [9];
...
For a selected sidelink grant, the minimum time gap between any two selected
resources (except for consecutive resources) comprises:

| | |
|---|---|
| - | a time gap between the end of the last symbol of a PSSCH transmission of the |

first resource and the start of the first symbol of the corresponding PSFCH reception
determined by sl-MinTimeGapPSFCH and sl-PSFCH-Period for the pool of
resources; and

| | |
|---|---|
| - | a time required for PSFCH reception and processing plus sidelink retransmission |

preparation including multiplexing of necessary physical channels and any TX-
RX/RX-TX switching time.

| | |
|---|---|
| NOTE 4: | How to determine the time required for PSFCH reception and |

processing plus sidelink retransmission preparation is left to UE implementation.

FIG. 4 illustrates a method performed by a UE for wireless communication according to some embodiments of the present disclosure.

In operation 401, the UE may perform operation A): determine a first number of consecutive resources based on a HARQ transmission number of a MAC PDU and a total number of available resources in a CO. In operation 402, the UE may perform operation B): select the first number of consecutive resources from a resource set indicated by a physical layer. For example, the UE may determine the target consecutive resource number as described in operation 3, then in operation 4, the UE may select the target consecutive resource number of consecutive resources from a resource set indicated by a physical layer.

In some embodiments, the first number equals a smaller one of the HARQ transmission number and the total number of available resources of a CO.

In some embodiments, the UE may update the first number of consecutive resources by subtracting the first number by one in the case that the operation B) of selecting the first number of consecutive resources failed; and the UE may perform the operation B) again after updating the first number of consecutive resources. For example, in the operation 5, the UE may subtract N_timeresource by 1, and may perform the operation 4 again.

In some embodiments, the UE may determine a remaining number of HARQ transmissions for the MAC PDU by subtracsting the HARQ transmission number by the first number in the case that the first number is less than the HARQ transmission number; and the UE may select resources for the remaining number of HARQ transmissions for the MAC PDU from one or more remaining resources in the resource set indicated by the physical layer. For example, in operation 6, the UE determine the left HARQ transmission number for the MAC PDU, i.e. N_leftnumber.

In some embodiments, the UE may perform operation C): select a set of periodic consecutive resources, wherein each period includes the first number of consecutive resources. For example, in operation f, the UE may use the randomly selected resources, i.e. the N_timeresource conservative resources selected in operation d, to select a set of periodic resources.

In some embodiments, the UE may perform operation D): update the first number of consecutive resources by subtracting the first number by one in the case that the operation C) of selecting the set of periodic consecutive resources failed; and the UE may perform the operation B) again after operation D). For example, in operation g, in the case that operation 4 failed, the UE may update the N_timeresource by subtracting N_timeresource by 1, and perform operation d again.

In some embodiments, the periodic consecutive resources are associated with a number of transmission opportunities for multiple MAC PDUs.

In some embodiments, the UE may determine a remaining number of HARQ transmissions for the MAC PDU by subtracting the HARQ transmission number by the first number in the case that the first number is less than the HARQ transmission number; and the UE may select resources for the remaining number of HARQ transmissions for the MAC PDU from one or more remaining resources in the resource set indicated by the physical layer.

In some embodiments, the UE may determine the resource set based on an internal threshold, wherein the internal threshold is associated with an energy detection threshold for a LBT procedure and a ratio of available resources and total resources in the CO.

In some embodiments, there is no minimum time gap between two consecutive resources among the first number of consecutive resources.

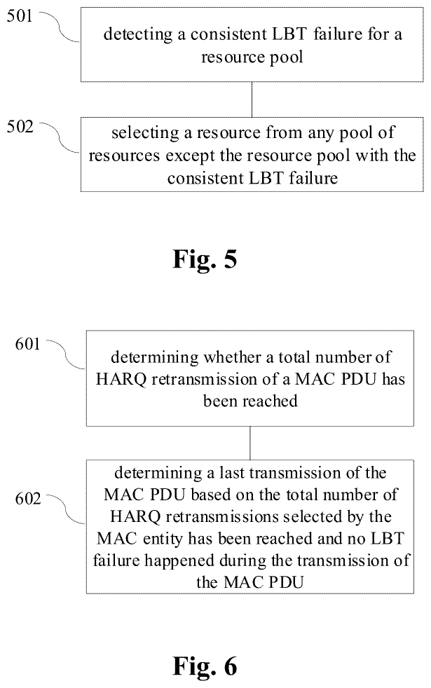

FIG. 5 illustrates a method performed by a UE for wireless communication according to some embodiments of the present disclosure.

In operation 501, the UE may detect a consistent LBT failure for a resource pool; and in operation 502, the UE may select a resource from any pool of resources except the resource pool with the consistent LBT failure.

FIG. 6 illustrates a method performed by a UE for wireless communication according to some embodiments of the present disclosure.

In operation 601, the UE may determine whether a total number of HARQ retransmission of a MAC PDU has been reached; and in operation 602, the UE may determine a last transmission of the MAC PDU based on the total number of HARQ retransmissions selected by the MAC entity has been reached and no LBT failure happened during the transmission of the MAC PDU.

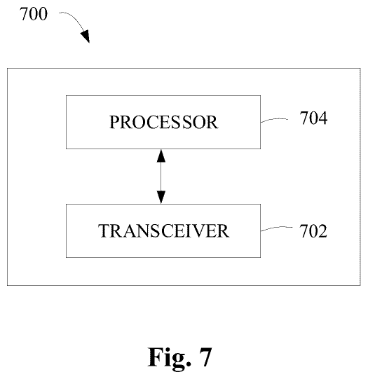

FIG. 7 illustrates a simplified block diagram of an exemplary apparatus according to some embodiments of the present disclosure.

As shown in FIG. 7, the apparatus 700 may include at least one processor 704 and at least one transceiver 702 coupled to the processor 704. The apparatus 700 may be or include at least part of a UE or a BS.

Although in this figure, elements such as the transceiver 702 and the processor 704 are described in the singular, the plural is contemplated unless a limitation to the singular is explicitly stated. In some embodiments of the present disclosure, the transceiver 702 may be divided into two devices, such as a receiving circuitry and a transmitting circuitry. In some embodiments of the present disclosure, the apparatus 700 may further include an input device, a memory, and/or other components.

In some embodiments of the present disclosure, the apparatus 700 may be a UE. The transceiver 702 and the processor 704 may interact with each other so as to perform the operations of the UE described with respect to any of FIGS. 1-6. In some embodiments of the present disclosure, the apparatus 700 may be a BS. The transceiver 702 and the processor 704 may interact with each other so as to perform the operations of the BS described with respect to any of FIGS. 1-6.

In some embodiments of the present disclosure, the apparatus 700 may further include at least one non-transitory computer-readable medium.

For example, in some embodiments of the present disclosure, the non-transitory computer-readable medium may have stored thereon computer-executable instructions to cause the processor 704 to implement any method performed by the UE as described above. For example, the computer-executable instructions, when executed, may cause the processor 704 interacting with the transceiver 702 to perform the operations of the UE described with respect to any of FIGS. 1-6.

In some embodiments of the present disclosure, the non-transitory computer-readable medium may have stored thereon computer-executable instructions to cause the processor 704 to implement any method performed by the BS as described above. For example, the computer-executable instructions, when executed, may cause the processor 704 interacting with the transceiver 702 to perform the operations of the BS described with respect to any of FIGS. 1-6.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
determine a first number of consecutive resources based on a hybrid automatic repeat request (HARQ) transmission number of a medium access control protocol data unit (MAC PDU) and a total number of available resources in a channel occupancy time (COT); and
select the first number of consecutive resources from a resource set indicated by a physical layer.

2. The UE of claim 1, wherein the first number equals a smaller one of the HARQ transmission number and the total number of available resources of a COT.

3. The UE of claim 1, wherein the at least one processor is further configured to cause the UE to:
update the first number of consecutive resources by subtracting the first number by one when the UE cannot select the first number of consecutive resources from a resource set indicated by a physical layer; and
select the updated first number of consecutive resources from the resource set indicated by the physical layer after updating the first number of consecutive resources.

4. The UE of claim 1, wherein the at least one processor is further configured to cause the UE to:
determine a remaining number of HARQ transmissions for the MAC PDU by subtracting the HARQ transmission number by the first number when the first number is less than the HARQ transmission number; and
select resources for the remaining number of HARQ transmissions for the MAC PDU from one or more remaining resources in the resource set indicated by the physical layer.

5. The UE of claim 1, wherein the at least one processor is further configured to cause the UE to:
select a set of periodic consecutive resources, wherein each period includes the first number of consecutive resources.

6. The UE of claim 5, wherein the at least one processor is further configured to cause the UE to:
update the first number of consecutive resources by subtracting the first number by one when selecting the set of periodic consecutive resources fails; and
select the first number of consecutive resources from the resource set indicated by the physical layer.

7. The UE of claim 5, wherein the periodic consecutive resources are associated with a number of transmission opportunities for multiple MAC PDUs.

8. The UE of claim 5, wherein the at least one processor is further configured to cause the UE to:
determine a remaining number of HARQ transmissions for the MAC PDU by subtracting the HARQ transmission number by the first number when the first number is less than the HARQ transmission number; and
select resources for the remaining number of HARQ transmissions for the MAC PDU from one or more remaining resources in the resource set indicated by the physical layer.

9. The UE of claim 1, wherein the at least processor is further configured to cause the UE to:
determine the resource set based on an internal threshold, wherein the internal threshold is associated with an energy detection threshold for a listen before talk (LBT) procedure and a ratio of available resources and total resources in the CO.

10. The UE of claim 1, wherein there is no minimum time gap between two consecutive resources among the first number of consecutive resources.

11. A user equipment (UE) for wireless communication, comprising:
at least one memory; and
at least one processor coupled with the at least one memory and configured to cause the UE to:
detect a consistent listen before talk (LBT) failure for a resource pool; and
select a resource from any pool of resources except the resource pool with the consistent LBT failure.

12. A user equipment (UE) for wireless communication, comprising:
at least one memory; and
at least one processor coupled with the at least one memory and configured to cause the UE to:
determine whether a total number of hybrid automatic repeat request (HARQ) retransmission of a medium access control protocol data unit (MAC PDU) has been reached; and
determine a last transmission of the MAC PDU based on the total number of HARQ retransmissions selected by the MAC entity has been reached and no LBT failure happened during the transmission of the MAC PDU.

13. A processor for wireless communication, comprising:
at least one controller coupled with the at least one memory and configured to cause the processor to:
determine a first number of consecutive resources based on a hybrid automatic repeat request (HARQ) transmission number of a medium access control protocol data unit (MAC PDU) and a total number of available resources in a channel occupancy (CO); and
select the first number of consecutive resources from a resource set indicated by a physical layer.

14. The processor of claim 13, wherein the first number equals a smaller one of the HARQ transmission number and the total number of available resources of a CO.

15. The processor of claim 13, wherein the at least one controller is further configured to cause the processor to:
update the first number of consecutive resources by subtracting the first number by one when the UE cannot select the first number of consecutive resources from a resource set indicated by a physical layer; and
select the updated first number of consecutive resources from the resource set indicated by the physical layer after updating the first number of consecutive resources.

16. The processor of claim 13, wherein the at least one controller is further configured to cause the processor to:
determine a remaining number of HARQ transmissions for the MAC PDU by subtracting the HARQ transmission number by the first number when the first number is less than the HARQ transmission number; and
select resources for the remaining number of HARQ transmissions for the MAC PDU from one or more remaining resources in the resource set indicated by the physical layer.

17. The processor of claim 13, wherein the at least one controller is further configured to cause the processor to:
select a set of periodic consecutive resources, wherein each period includes the first number of consecutive resources.

18. The processor of claim 17, wherein the at least one controller is further configured to cause the processor to:
update the first number of consecutive resources by subtracting the first number by one when selecting the set of periodic consecutive resources fails; and
select the first number of consecutive resources from the resource set indicated by the physical layer.

19. The processor of claim 17, wherein the periodic consecutive resources are associated with a number of transmission opportunities for multiple MAC PDUs.

20. The processor of claim 13, wherein the at least controller is further configured to cause the processor to:
determine the resource set based on an internal threshold, wherein the internal threshold is associated with an energy detection threshold for a listen before talk (LBT) procedure and a ratio of available resources and total resources in the CO.
